(19) United States
(12) Patent Application Publication
(10) Pub. No.: US 2011/0311754 A1
(43) Pub. Date: Dec. 22, 2011

(54) Ground Cover for Surrounding an Upright Element

(76) Inventor: James E. Kray, Wheaton, IL (US)

(21) Appl. No.: 13/113,600

(22) Filed: May 23, 2011

Related U.S. Application Data
(60) Provisional application No. 61/355,993, filed on Jun. 17, 2010.

(51) Int. Cl. B32B 3/02

(52) U.S. Cl. 428/66.6

(57) ABSTRACT

A cover for surrounding the base of an upright element. The cover has a disc shaped body. The disc shaped body has a central opening in communication with a seam which allows for a user to surround the base of the upright element with the cover. The disc shaped body has a ridged surface featuring concentric circles of decreasing size as height increases. The underside of the disc shaped member has a plurality of supporting frames with a shape that is complementary to the ridges of the concentric circles.

This application claims the benefit of U.S. Provisional Application No. 61/355,993 filed Jun. 17, 2010.

### FIELD OF THE INVENTION

This invention relates to the field of coverings for the base of objects extending from the ground.

### BACKGROUND OF THE INVENTION

Objects such as sign posts, and lamp posts are common upright elements which extend from the ground. The surface of the ground can vary from grass or dirt to concrete, sand, asphalt, and various other types of common ground surfaces. Often, unsightly growth of grass, weeds, and other vegetation in the area surrounding the base of the upright elements occur. Due to the proximity of the unwanted vegetation to the upright structure, it is difficult to eliminate the unsightly growth using conventional lawn cutting machinery. Thus it is beneficial to have a device which is aesthetically pleasing, and inhibits the growth of unwanted grass or weeds near or around the base of a post. Such a device may also be used to prevent the growth of unwanted grass or weeds at the base of a tree, such as in between the roots of the trees. The presence of unwanted growth at the base of a tree may often times be difficult to remove using conventional lawn cutting machinery since the growth may be dispersed between the roots of the trees.

Upright elements such as posts may also be susceptible to undesirable water seepage into the area surrounding the post. Water seepage into the area between the post and the supporting environment can cause erosion, molding, or loosen the stability of the post. In regions with harsh winters, it is also desirable to protect the base of upright elements such as poles and trees from snow, slush, or salt.

The present inventor has recognized the need for a covering around the base of upright elements to prevent unwanted growth of vegetation.

The present inventor has recognized the need for a covering around the base of upright elements which can assist in diverting water away from the base of the upright element.

The present inventor has recognized the need to prevent undesirable exposure to outdoor weather elements with a covering around the base of upright elements which maintains its shape in response to outdoor elements over time.

The present inventor has recognized it would be desirable to protect the upright elements from damage caused by the mowing and trimming devices. Further the inventors have recognized that it would be desirable for reduce the area in need of mowing and other maintenance. The reduction may result in reduced fuel use and related emissions when devices that consume fuel are used to carry out that maintenance.

### SUMMARY OF THE INVENTION

A covering for the base of an upright element comprising a disc shaped body. The disc shaped body has a central opening in communication with a seam which allows for a user to surround the base of the upright element with the covering. The disc shaped body has a ridged or stepped surface featuring concentric circles of decreasing size as height increases from the periphery towards the center of the body. The underside of the disc shaped body comprises a plurality of supporting frames with a shape that is complementary to the steps formed by the concentric circles.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a perspective top view of an exemplary embodiment of the cover.

FIG. 2 illustrates a tilted side view of an exemplary embodiment of the cover.

FIG. 3 illustrates a perspective view of the underside of an exemplary embodiment of the cover.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

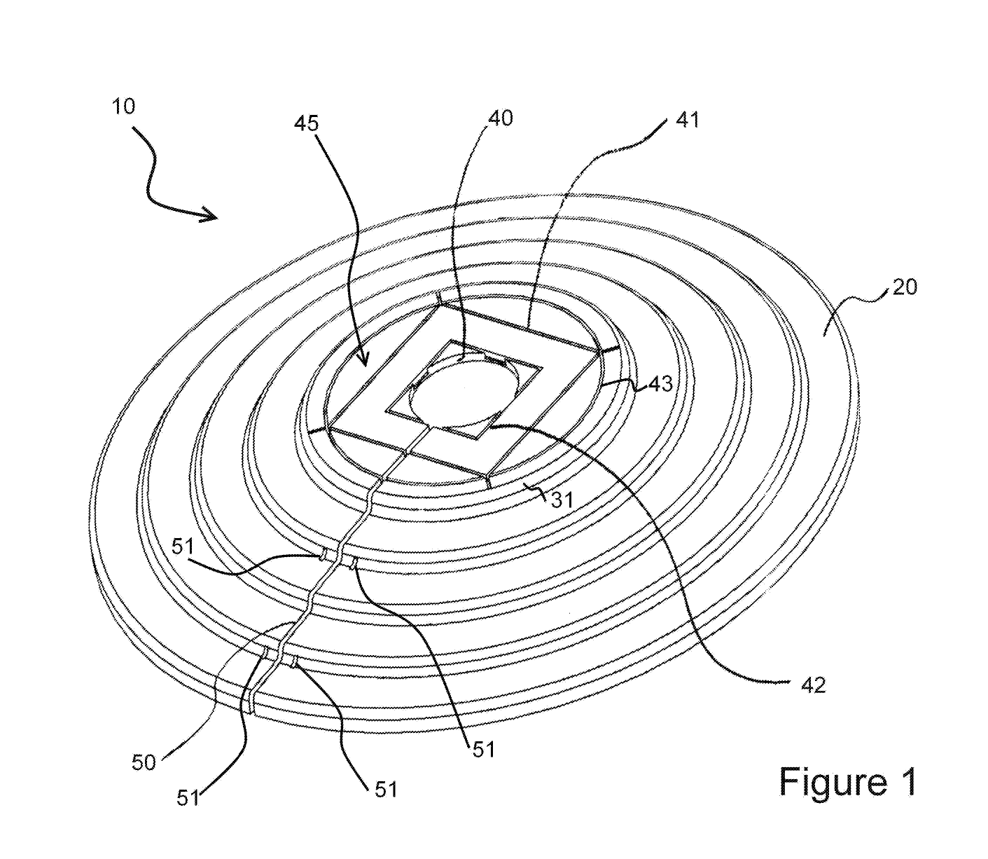

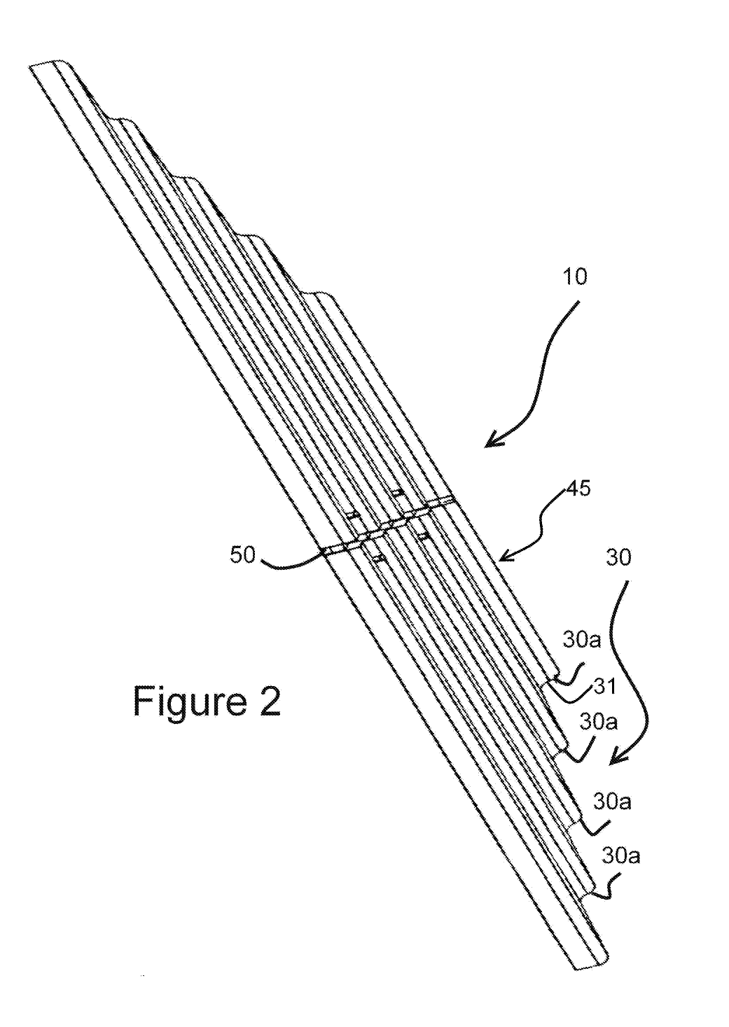

FIG. 1 illustrates a perspective view of one embodiment of a cover for an upright element such as a post. It will be understood that the cover can be used with upright elements that extend upward from a ground surface. The cover may be used with upright elements that meet the ground at an angle other than 90 degrees. The cover 10 comprises a disc shaped body 20 having a stepped surface 30 (FIG. 2), with steps 30a which are the side walls of concentric circles. The concentric circles decrease in diameter as height of the cover increases. Because the surface of the body increases in height in a direction from the periphery to the center of the cover, the cover 10, in the embodiment shown in FIG. 1, has a generally frustoconical shape. The topmost step 31 extends into a circular region comprising the central portion 45.

The body 20 has a central opening 40 within the central portion 45, through which an upright element can extend. The central opening 40 is in communication with a seam 50. Seam 50 allows the cover 10 to be positioned around the base of the upright element by permitting the ends of the body to be moved apart from each other. The central opening as illustrated in FIG. 1 is a circular opening. The central opening may also be other shapes, such as a rectangle or square, to accommodate upright elements of different cross sectional shapes and sizes. In the embodiment illustrated in FIG. 1, the central opening 40 is a circular shape which is inscribed within a rectangular groove 42. The rectangular groove 42 is disposed within a larger rectangular groove 41. The rectangular groove is inscribed within a circular groove 43. A user is able to change the shape of the central opening 40 from a circle to a rectangle 42 or a larger rectangle 41 or larger circle 43 by cutting along the groove lines of the desired shape.

The cover can be made from a flexible, water resistant material, such as rubber or silicone. Other polymeric materials, natural or synthetic, or a combination thereof can also be used. In one embodiment, the cover is a rubber disk of 14 inches (35 cm) diameter, with ⅜ inch (0.94 cm) height at the outermost perimeter, rising to approximately 1.5 inches (3.75 cm) at the top. The top concentric circle may have a diameter of 5 inches (12.5 cm). In the embodiment illustrated in FIG. 1, the body 20 comprises five concentric circles.

Because the cover is flexible, the user can flex or bend the cover as needed to open the seam to wrap the cover around the upright element so that the upright element will extend through the central opening 40. The seam 50 can be connected once the cover 10 is disposed around an upright element. To connect the seam 50, an adhesive, such as glue, can be used to join the opposing sides of the seam. The glue is water resistant and suitable for connecting the material, such as rubber, used for the cover. In other embodiment, at least one of the opposing sides of the seam may comprise a pre-applied adhesive layer protected by a covering. When the cover 10 is disposed in position around the base of the upright element, the user can peel off the protective covering to expose the adhesive edge. The opposing sides of the seam are then pressed together to join the seam. Various other methods to join the seam can be used. For example, the seam may be joined by a mechanical engagement, or one side of the seam can overlap with a portion of the opposite side. In one embodiment, the sides of the seams may be pressed together by using a mechanism for tying the opposite sides of the seams together. The mechanism can be a cable tie which engages with slots 51 on either side of the seam to receive the cable tie. The cable tie is then pulled tight to secure the seam. Any other method known to one skilled in the art can be used to join the opposite sides of the seams.

FIG. 2 illustrates a side view of the cover 10, with the stepped profile 30a, visible. Without wishing to be bound by any particular theory, it is believed that the stepped profile allows more efficient transfer of water away from the center of the cover. Water accumulating from the top of the cover 10, is then dispersed evenly by the stepped profile when it is transferred to the ground. The edges of each step 30a is rounded to provide a smooth surface and to facilitate the flow of water, or other debris, from one step to the lower step, in a direction away from the upright element.

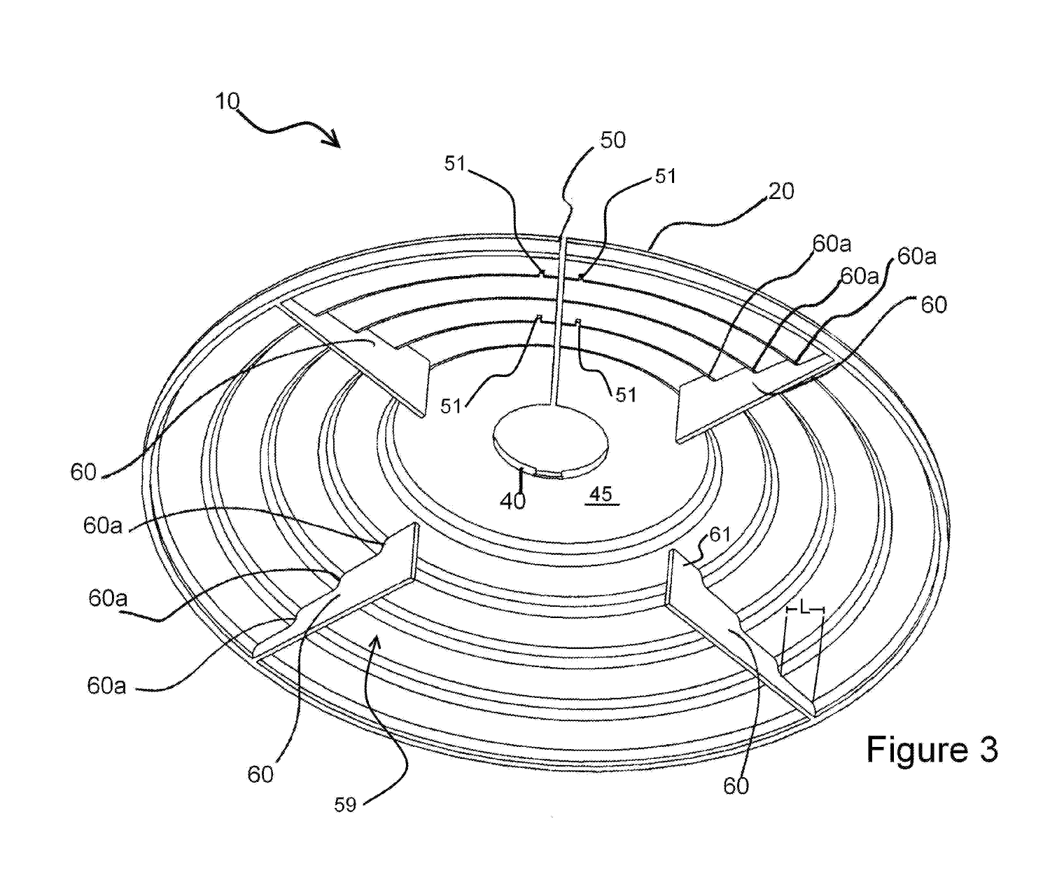

FIG. 3 illustrates a perspective view of the underside of the cover 10. As illustrated in the embodiment shown in FIG. 3, the cover 10 comprises a support system 59 on the underside of the cover 10. The support system 59 comprises supporting frames 60 in contact with the underside of the stepped configuration of each of the steps 30a. Alternatively, the supporting frames can extend just short of the topmost step 31 which comprises the central portion 45. Supporting frames 60 have ridges 60a arranged and shaped complementarily to the steps 30a. Each ridge, may extend for a length “L” equal to the length of a step 30a. The topmost ridge 61 may extend until the topmost step 31, or it may terminate before the center portion 45. In one embodiment, the supporting frames 60 extend from the rim or periphery of the disk-shaped body, and terminate before the center portion 45. Alternately, the supporting frames can extend from the rim or periphery and terminate within the central portion just after the topmost step 31. The topmost ridge 61 should be of a length not extending beyond the central opening or the central opening a user has selected by cutting along grooves 41, 42, 43.

FIG. 3 illustrates that four supporting frames 60 can be used to support the cover 10. However, more or fewer supporting frames 60 can be used. Supporting frames 60 can be positioned in any orientation, and need not be evenly spaced apart about the central opening. An evenly spaced apart first set of supporting frames 60, as illustrated in FIG. 3, are oriented at 90 degrees to a second set of support frames. However, the distance between supporting frames can be arranged as needed depending on the topography of the ground surface. The supporting frames 60 can be adjustable, or they may be secured to the bottom surface of the cover 10. The supporting frames 60 may be molded as one unitary piece with the disc shaped body.

In the embodiments illustrated in FIGS. 1-3, the disk-shaped body is circular. In other embodiments, any other shape can be used, such as a regular or irregular polygon, or any other arbitrary shape. Arbitrary shapes can be used for decorative purposes or to accommodate the nature of the landscaping topography.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A cover for surrounding an upright element extending upward from the ground comprising:
a disc shaped body with a central opening;
a seam extending from the central opening to the periphery of the body;
said disk-shaped body having a ridged surface, said ridged surface supported on the underside of the body by a supporting frame.

2. The cover of claim 1 wherein the ridged surface comprises a plurality of stacked concentric circles having increasing smaller sizes as height of the disc increases from the periphery to the center of the body, said central opening disposed in a top most concentric circle.

3. The cover of claim 2 further comprising at least one groove on the surface of the top most concentric circle.

4. The cover of claim 3 wherein the at least one groove is arranged in a rectangular shape.

5. The cover of claim 4 wherein the at least one groove is arranged in a circular shape.

6. The cover of claim 1 wherein the disk-shaped body is rectangular.

7. The cover of claim 1 wherein the seam is joined by an adhesive mechanism.

8. The cover of claim 7 wherein the adhesive mechanism is glue.

9. The cover of claim 7 wherein the adhesive mechanism is an adhesive strip having a cover which can be removed to expose the surface of the adhesive strip.

10. The cover of claim 1 wherein the seam is joined mechanically.

11. The cover of claim 1 wherein the supporting frames are complementarily shaped to the ridged surface.

12. The cover of claim 1 wherein the supporting frames are evenly spaced from each other about the central opening.

13. The cover of claim 1 wherein the peripheral edge of the body has a diameter of about 35 cm.

14. The cover of claim 1, wherein the frame comprises a first group of two frame member spaced apart and aligned across the central opening and a second group of two frame members spaced apart and aligned across the central opening; the first group of frame members perpendicular to the second group of claim members.

15. The cover of claim 1 wherein the ridged surface comprises ridges with rounded edges.

16. A disc-shaped member for surrounding a non-living upright element, comprising:
a flexible body comprising a stepped surface of a plurality of concentric circles,
said plurality of concentric circles having a topmost concentric circle which forms a central portion, the central portion having a central opening;
a seam extending from the central opening to the periphery of the flexible body to allow maneuvering of the flexible body for disposition about the upright element; and
a support system on an underside of the flexible body.

17. The disc-shaped member of claim 16 further comprising at least a pair of slots on opposing sides of the seam.

18. The disc-shaped member of claim 16 wherein the support system comprises support frames with ridges complementing the stepped surface of the flexible body, and wherein said support frames are evenly spaced apart about the central opening.

19. The disc-shaped member of claim 18 wherein the support frames extend from the periphery of the body to before the topmost concentric circle.

20. A system for surrounding the base of an upright element comprising:
a flexible body with a stepped configuration comprising a plurality of concentric geometric shapes, said upper most concentric geometric shape having a central opening;
a seam which joins two ends of the flexible body about an upright element; and a support system on an underside of the flexible body, the support system comprising support frames in contact with the underside of the flexible body, said support frames having ridges complementarily shaped to accommodate the plurality of concentric geometric shapes.
